(19) United States
(12) Patent Application Publication
(10) Pub. No.: US 2009/0266705 A1
(43) Pub. Date: Oct. 29, 2009

(54) METHOD OF MANUFACTURING VERTICAL MAGNETIC HEAD

(75) Inventors: Kentaro Suzuki, Kawasaki (JP); Kazuaki Satoh, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/333,075

(22) Filed: Dec. 11, 2008

(30) Foreign Application Priority Data
Apr. 28, 2008 (JP) 2008-117348

(51) Int. Cl. B44C 1/22

(52) U.S. Cl. 204/192.32

(57) ABSTRACT

The method of manufacturing a vertical magnetic head comprises the steps of: forming a resist pattern including a concave section on a wafer substrate; laminating a plurality of films in the concave section until forming a prescribed multilayer structure of the main magnetic pole; and removing the resist pattern. Inner faces of the concave section are perpendicular to a surface of the wafer substrate. The laminating step includes the sub-steps of: (a) performing a sputtering process, in which particles are perpendicularly sputtered with respect to the surface of the wafer substrate, a plurality of times so as to laminate a plurality of sputtered films in the concave section; and (b) removing the sputtered films, which have been stuck on the resist pattern in the sub-step (a), from the resist pattern. The sub-steps (a) and (b) are repeated until the prescribed multilayer structure is formed.

### BACKGROUND OF THE INVENTION

The present invention relates to a method of manufacturing a vertical magnetic head, more precisely relates to a method of manufacturing a vertical magnetic head whose main magnetic pole has a multilayer structure.

Vertical magnetic heads have been developed because they are capable of increasing plane recording density of recording media. A main magnetic pole of the vertical magnetic head is a single magnetic pole, so intensity of a leakage magnetic field leaked from the main magnetic pole cannot be sufficiently reduced after performing a recording action. Therefore, a problem of pole erase, in which date recorded in a recording medium are erased or garbled, occurs. The main magnetic pole is composed of a magnetic material having high saturation magnetic flux density (high B_{S} value). Generally, in the magnetic material having a high Bs value, a soft magnetic characteristic is insufficient and residual magnetization is great, so the material causes the problem of pole erase.

To solve the problem of pole erase caused by the main magnetic pole of the vertical magnetic head, the main magnetic pole is formed into a multi layer structure, by laminating a plurality of films, so as to maintain a high Bs value and improve the soft magnetic characteristic.

The multilayer structure of the main magnetic pole is formed by an ion trimming (ion milling) process or a Damascene method. In the ion trimming process, a multi layer structure, from which a number of main magnetic poles will be formed, is formed on an entire surface of a wafer substrate, and then the multi layer structure is ion-trimmed to form into prescribed patterns of the main magnetic poles. On the other hand, in the Damascene method, an insulating layer composed of, for example, alumina is formed on a substrate, a groove whose configuration corresponds to a main magnetic pole is formed in the insulating layer, and a multilayer structure of the main magnetic pole is formed in the groove.

The above described conventional methods are disclosed in, for example, Japanese Laid-open Patent Publications No. 5-29172, No. 2007-95304 and No. 2005-346923.

By increasing plane recording density of recording media, main magnetic poles of recording heads are highly downsized. Therefore, the main magnetic heads must be highly precisely processed. In the above described method wherein the main magnetic poles are formed by the ion trimming process, the main magnetic poles are formed from the multi layer structure formed on the entire surface of the wafer substrate, but it is difficult to evenly precisely form the main magnetic poles in the entire surface. In the ion trimming process, shapes of the main magnetic poles are defined by ion trimming, so dispersion of the ion trimming directly influences production accuracy.

On the other hand, by the Damascene method, the main magnetic pole is formed by laminating films on an inner bottom face of the groove. A shape of the groove corresponds to that of the main magnetic pole. A cross-section of the main magnetic pole along an air bearing surface is formed into a rectangular shape, in which a depth is longer than a width. If the films are merely laminated by a sputtering process, an opening part of the groove will be closed by sputtered films and the laminated films will be curved and laminated in the groove. Namely, the films cannot be flatly laminated in the groove. This problem significantly occurs in minute main magnetic poles formed in grooves having narrow opening parts.

### SUMMARY OF THE INVENTION

The present invention was conceived to solve the above described problems.

An object of the present invention is to provide a suitable method of manufacturing a vertical magnetic head, whose main magnetic pole is constituted by films flatly and orderly laminated and which has a prescribed write characteristic.

To achieve the object, the present invention has following constitutions.

Namely, the method of manufacturing a vertical magnetic head of the present invention comprises the steps of: forming a resist pattern including a concave section, whose planar shape corresponds to that of a main magnetic pole to be formed, on a wafer substrate; laminating a plurality of films in the concave section until forming a prescribed multilayer structure of the main magnetic pole; and removing the resist pattern after laminating the films, inner faces of the concave section are perpendicular to a surface of the wafer substrate in the forming step, the laminating step includes the sub-steps of: (a) performing a sputtering process, in which particles are perpendicularly sputtered with respect to the surface of the wafer substrate, a prescribed number of times so as to flatly laminate the sputtered films in the concave section; and (b) removing the sputtered films, which have been stuck on a surface of the resist pattern in the sub-step (a), from the surface of the resist pattern by an abrasive process, and the sub-steps (a) and (b) are repeated, in the laminating step, until the prescribed multilayer structure is formed.

Note that, by performing the sputtering process the prescribed number of times described in the sub-step (a), the sputtered films can be flatly and orderly laminated, without being curved, in the concave section.

In the method, a cross-section of a pole end part of the main magnetic pole may be formed into an inverted trapezoidal shape, by an ion trimming process, after the removing step. By ion-trimming the pole end part after a planar shape of the main magnetic pole is formed into a prescribed shape with the resist pattern, the pole end part of the main magnetic pole can be accurately formed.

In the method, the sub-step (a) may be performed by a point-cusp magnetic field (PCM) sputtering apparatus. With this method, the particles can be perpendicularly sputtered with respect to the surface of the wafer substrate so as to flatly form the sputtered films in the concave section of the resist pattern.

In the method, a position of exposing the surface of the resist pattern may be detected as a terminal point of the abrasive process of the sub-step (b). With this method, the sputtered films stuck on the surface of the resist pattern can be securely removed.

In the method, a stopper film may be formed on the surface of the resist pattern after the forming step, and the stopper film may be used as a stopper of the abrasive process of the sub-step (b). With this method, the abrasive process is limited by the stopper film so that the sputtered films stuck on the surface of the resist pattern can be perfectly removed.

In the method of the present invention, the sputtered films can be flatly and orderly laminated in the concave section of the resist pattern, so that the main magnetic pole having the suitable multilayer structure can be securely formed. Therefore, the write characteristic of the vertical magnetic head can be produced.

### BRIEF DESCRIPTION OF THE DRAWINGS

Embodiments of the present invention will now be described by way of examples and with reference to the accompanying drawings, in which:

FIG. 1 is a sectional view of a vertical magnetic head produced by the method relating to the present invention;

FIGS. 2A-2G are explanation views showing a method of forming a main magnetic pole of the vertical magnetic head;

FIG. 3 is a plan view of a concave section formed in a resist pattern; and

FIGS. 4A-4G are explanation views showing another method of forming the main magnetic pole of the vertical magnetic head.

### DETAILED DESCRIPTION OF THE EMBODIMENTS

Preferred embodiments of the present invention will now be described in detail with reference to the accompanying drawings.

### (Vertical Magnetic Head)

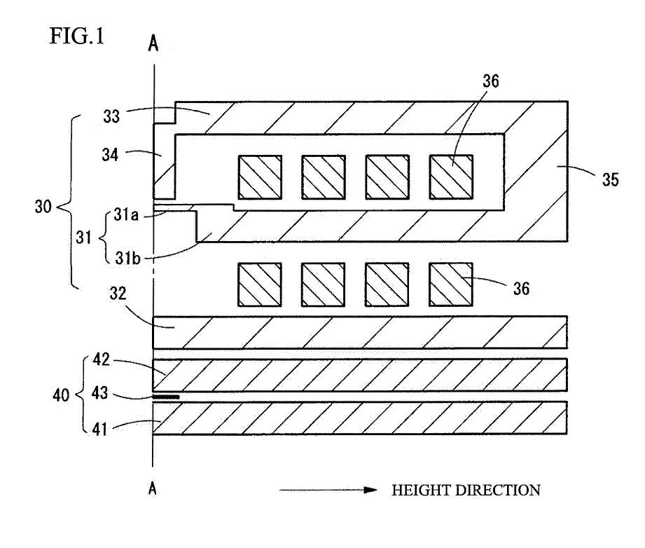

FIG. 1 shows a cross-section of a vertical magnetic head perpendicular to an air bearing surface, which is formed along a line A-A. The vertical magnetic head includes a vertical recording head 30 and a read head 40.

The recording head 30 has a main magnetic pole 31, a first return yoke 32 and a second return yoke 33. A neck section 31a is formed at a front end of the main magnetic pole 31 located on the air bearing surface side; a yoke section 31b, whose width is gradually increased in the height direction, is formed on the rear side of the neck section 31a.

A trailing shield 34, which faces the main magnetic pole 31, is formed at a front end of the second return yoke 33. The main magnetic pole 31 and the second return yoke 53 are connected by a back gap 35. A coil 36 is wound around the yoke section 31b. Note that, in the present embodiment, only the main magnetic pole 31 and the second return yoke 53 are connected by the back gap 35. The main magnetic pole 31, the second return yoke 53 and the first return yoke 32 may be connected by the back gap. The present invention can be applied to main magnetic poles of various types of vertical magnetic heads.

The read head 40 has a lower shielding layer 41, an upper shielding layer 42 and a read element 43. Note that, in FIG. 1, spaces between the adjacent layers are filled with a nonmagnetic insulating material, e.g., alumina.

### (Method of Manufacturing Vertical Magnetic Head)

The present invention is characterized by the production process of forming the main magnetic pole of the recording head of the vertical magnetic head. Thus, the production process of forming the main magnetic pole will be explained.

As shown in FIG. 1, the front end part of the main magnetic pole 31 of the vertical magnetic head, which will constitute the air bearing surface, is the neck section 31a. An end face of the neck section 31a is micronized to increase plane recording density, so that data can be highly densely recorded in a recording medium.

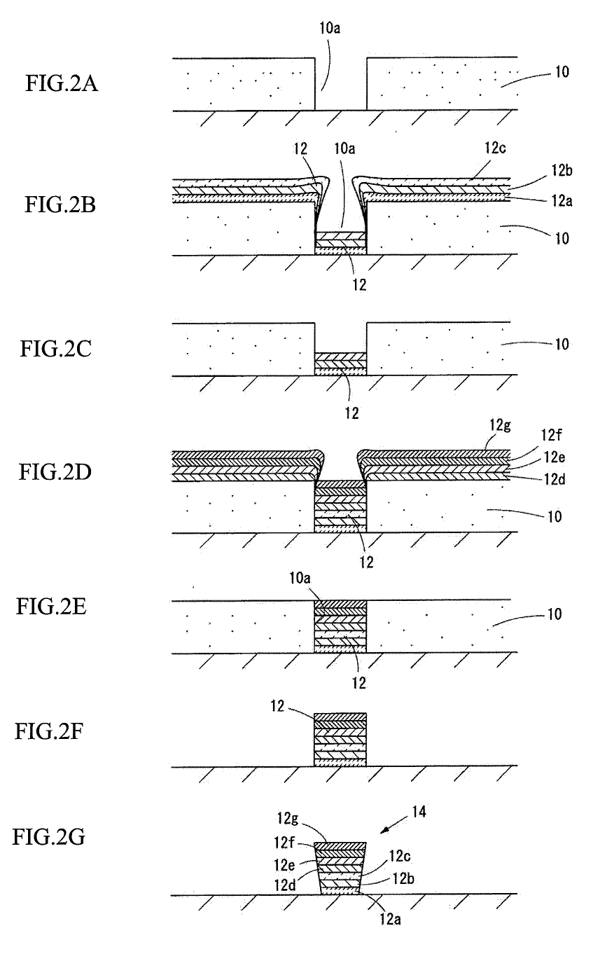

FIGS. 2A-2G are explanation views showing a method of forming the main magnetic pole of the vertical magnetic head on a wafer substrate.

In FIG. 2A, a resist pattern 10, whose planar shape corresponds to that of the main magnetic pole to be formed, on the wafer substrate. In fact, an insulating layer is formed on the entire surface of the wafer substrate by sputtering an insulating material, e.g., alumina, the surface of the insulating layer is polished, by a chemical mechanical polishing (CMP) process, so as to flatten the surface, and then the resist pattern 10 is formed thereon. Since the surface of the insulating layer is flattened and then the resist pattern 10 is formed thereon, the resist pattern 10 for forming the main magnetic pole can be accurately patterned.

The resist pattern 10 is formed by applying resist on the surface of the wafer substrate and optically exposing and developing the resist so as to form a concave section, e.g., groove, in which the main magnetic pole will be formed. In fact, a number of the concave sections are formed in the wafer substrate, but one of them is shown in FIGS. 2A-2G for a simple explanation.

FIG. 2A shows a cross-section of the concave section 10a, which is formed in the resist pattern 10, taken along a plane corresponding to the air bearing surface to be formed.

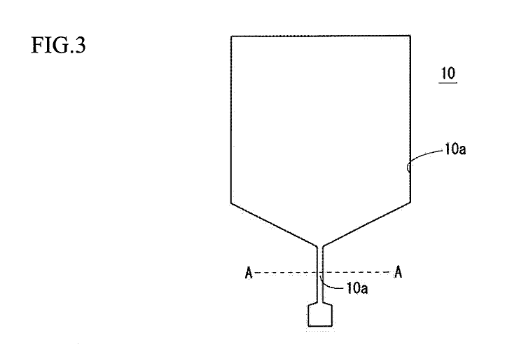

FIG. 3 is a plan view of the resist pattern 10. As described above, the front end part of the main magnetic pole, which is located in the vicinity of the air bearing surface, is narrowed, and the main magnetic pole is gradually widened, on the rear side of the front end part, in the height direction until reaching a prescribed width. Therefore, a front end part of the concave section 10a, which is located in the vicinity of a pole end (air bearing surface), is narrowed; an intermediate part of the concave section 10a, which is located on the rear side of the front end part, is gradually widened until reaching the prescribed width; and a rear part of the concave section 10a is extended rearward with maintaining the prescribed width. A number of the concave sections 10a, each of which corresponds to each of the magnetic heads, are formed on the wafer substrate. Note that, a line A-A indicates a position of the air bearing surface to be formed.

In FIG. 2B, a sputtering process is performed to the wafer substrate, on which the resist patter 10 has been formed, a plurality of times, with changing targets. Therefore, a plurality of sputtered films 12 are laminated on an inner bottom face of the concave section 10a. This step is a first film forming step.

In a multilayer structure of the main magnetic pole, materials and thicknesses of the films to be laminated are previously designed. In the sputtering process shown in FIG. 2B, the targets are selected and thicknesses of the films are controlled on the basis of the predetermined design. There are various types of multilayer structures of the main magnetic poles. The types are selected on the basis of products. For example, the multilayer structure of the main magnetic pole is constituted by 2-8 films, which include magnetic films composed of Co or Cr and nonmagnetic films and whose thicknesses are from several nm to several dozen nm.

In case of forming the sputtered films on the wafer substrate, suitable sputtering conditions are designed so as to flatly and orderly laminate the sputtered films 12 on the inner bottom face of the concave section 10a with highly preventing the sputtered films 12 from adhering on inner wall faces of the concave section 10a.

Namely, in the present embodiment, the inner wall faces of the concave section 10a of the resist pattern 10 are perpendicularly extended from the surface of the wafer substrate, and particles are perpendicularly sputtered with respect to the surface of the wafer substrate.

To perpendicularly extend the inner wall faces of the concave section 10a from the surface of the wafer substrate, conditions of a thermal curing process performed after forming the resist pattern 10 are suitably designed.

When the films are formed by sputtering, the sputtered particles are perpendicularly applied to the surface of the wafer substrate by following methods: (1) widening a clearance between the wafer substrate and the target so as to improve linearity of the sputtered particles; (2) reducing a gas pressure for forming films so as to prevent dispersion of the particles while being sputtered; (3) increasing bias voltage of the wafer substrate so as to linearly draw the sputtered particles toward the wafer substrate; (4) selecting the sputtered particles, which are linearly sputtered toward the wafer substrate, by a collimator; and (5) using a point-cusp magnetic field (PCM) sputtering apparatus capable of performing vertical sputtering.

As described above, by perpendicularly applying the sputtered particles to the surface of the wafer substrate, in principle, no sputtered films stick onto the inner wall faces of the concave section 10a of the resist pattern 10. However, the sputtered films 12 are laminated on not only the inner bottom face of the concave section 10a but also the surface of the resist pattern 10. In FIG. 2B, three sputtered films 12a, 12b and 12c are laminated.

The sputtered films 12a, 12b and 12c laminated on the surface of the resist patter 10 rise along an edge of the concave section 10a and narrow an opening part of the concave section 10a. Further, the sputtered films 12 slightly stick onto the inner wall faces of the concave section 10a.

In the present invention, when the sputtering process is performed to the wafer substrate, the sputtering process is not repeated many times. An abrasive process, e.g., chemical mechanical polishing (CMP) process, is performed before the laminated films are unevenly formed in the concave section 10a.

By repeating the sputtering process to the wafer substrate, the opening part of the concave section 10a is gradually narrowed, by the sputtered films 12, as shown in FIG. 2B. In this state, the sputtered films 12 formed on the inner bottom face of the concave section 10a will be unevenly formed or curved. Namely, the sputtered films 12 cannot be flatly formed and laminated in the concave section 10a.

In the present invention, the sputtering process is repeated a prescribed number of times and once stopped before uneven films are formed in the concave section 10a. Then, the CMP process is performed, so that the sputtered films 12 can be flatly and orderly laminated in the concave section 10a.

In the present embodiment, as shown in FIG. 2B, the sputtering process is repeated three times. The number of performing the sputtering process may be optionally selected according to products. A lamination state of the sputtered films in the concave section 10a depends on a width and a depth of the concave section 10a, and materials and thicknesses of the films. Therefore, the number of continuously performing the sputtering process may be optionally determined according to products. For example, in case of forming the main magnetic pole having a two-layer structure, if a lower film is thicker, the CMP process may be performed after the lower film is formed by the sputtering process.

In fact, the prescribed number of performing the sputtering process without unevenly forming the films is previously determined by repeatedly performing the sputtering process and observing the lamination state of the sputtered films in the concave section 10a. The CMP process is performed after the sputtering process is repeatedly performed the prescribed number of times.

In FIG. 2C, the sputtered films 12 on the surface of the resist pattern 10 have been removed by the CMP process. In the CMP process, a position of exposing the surface of the resist pattern 10 is detected as a terminal point of the process. By performing the CMP process, the sputtered films 12 are flatly laminated in only the concave section 10a of the resist pattern 10.

In FIG. 2D, sputtered films 12D, 12E, 12F and 12G, which also constitute the main magnetic pole, are formed on the sputtered films 12, which have been already laminated in the concave section 10a, by repeatedly performing the sputtering process, as well as the former step shown in FIG. 2B. This step is a second film forming step. In this step too, the sputtered films 12D, 12E, 12F and 12G are respectively composed of prescribed materials and respectively formed until reaching prescribed thicknesses on the basis of the design of the multilayer structure of the main magnetic pole.

The sputtered films 12D, 12E, 12F and 12G are laminated on the sputtered films 12, which have been previously formed in the concave section 10a, and further stick onto the surface of the resist pattern 10. In this sputtering process too, the particles are perpendicularly sputtered with respect to the surface of the wafer substrate, and the sputtering process is repeatedly performed, without unevenly forming the films, so as to flatly and orderly laminate the films 12D, 12E, 12F and 12G in the concave section 10a.

In FIG. 2E, the sputtered films 12D, 12E, 12F and 12G on the surface of the resist pattern 10 have been removed by the CMP process. In the CMP process too, a position of exposing the surface of the resist pattern 10 is detected as the terminal point of the process. By performing the CMP process, the sputtered films 12, which constitute the prescribed multilayer structure of the main magnetic pole, are formed in the concave section 10a only, and the concave section 10a is filled with the sputtered films 12.

Note that, in the present embodiment, the concave section 10a of the resist pattern 10 is fully filled with the sputtered films 12 by performing the second film forming step. In other cases, if the concave section 10a is not fully filled with the sputtered films 12, the CMP process is further performed, and then a third or further film forming step may be performed. The number of performing the film forming steps may be determined according to a shape and a size of the main magnetic pole.

Namely, the multilayer structure of the main magnetic pole is formed in the concave section 10a by repeating the sputtering process and the CMP process the prescribed number of times.

Note that, in the later sputtering process or the later film forming step, the sputtered films 12 have been already formed in the concave section 10a, so the substantial depth of the concave section 10a is reduced. Therefore, possibility of forming uneven or curved films in the concave section 10a is gradually lowered.

In the present embodiment, the surface of the resist pattern 10 is regarded as the upmost layer of the main magnetic pole, so the CMP process is stopped when the terminal point, at which the surface of the resist pattern 10 is exposed, is detected.

If the thicknesses of the laminated films in the concave section 10a can be highly precisely controlled, the thickness of the resist pattern 10 may be slightly thicker than that of the main magnetic pole, and sputtered films 12 on the surface of the resist pattern 10 may be merely removed by the CMP process. In this case, the termination of removing the sputtered films 12 from the surface of the resist pattern 10 can be known by detecting the position of exposing the surface of the resist pattern 10.

In FIG. 2F, the resist pattern 10 has been removed from the surface of the wafer substrate in the following step.

In FIG. 2G, the pole end part of the main magnetic pole is formed into an inverted trapezoidal shape by an ion trimming process. By performing the ion trimming process, the pole end part is formed into a tapered shape, in which an inclination angle of side faces is about 5-10 degrees. FIG. 2G shows a cross-section of the completed main magnetic pole taken along the plane corresponding to the air bearing surface.

### (Another Method of Forming Main Magnetic Pole)

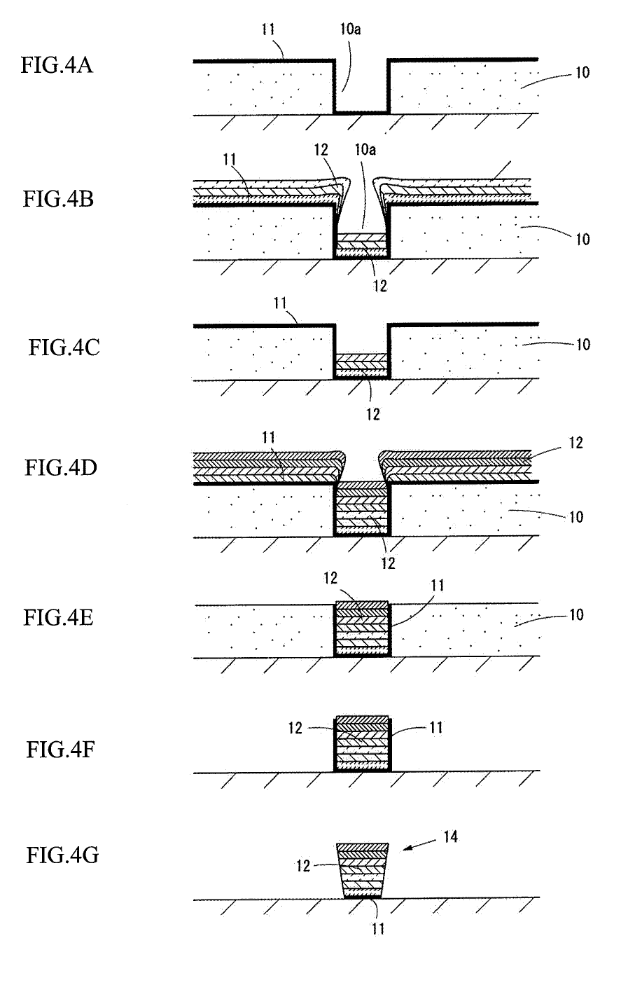

FIGS. 4A-4G are explanation views showing another method of forming the main magnetic pole of the vertical magnetic head. Note that, the structural elements described in the above described embodiment are assigned the same names and the same reference symbols, and explanation will be omitted. This embodiment is characterized in that the stopper film 11 is formed on the surface of the resist pattern 10 after forming the resist pattern 10 (FIG. 4A). The stopper film 11 is used as a stopper for limiting the CMP process when the sputtered films 12 are removed from the surface of the resist pattern 10 by the CMP process. For example, the stopper film is composed of Ta and formed by sputtering.

In FIG. 4B, the first film forming step is performed so as to form the sputtered films 12 on the wafer substrate. The stopper film 11 is formed on the inner bottom face of the concave section 10a, and the sputtered films 12 are laminated on the stopper film 11. Further, the sputtered films 12 are laminated on the stopper film 11 formed on the surface of the resist pattern 10.

In FIG. 4C, the sputtered films 12 formed on the surface of the resist pattern 10 are removed by the CMP process. In the present embodiment, the surface of the resist pattern 10 is coated with the stopper film 11, so the terminal point of the CMP process is defined by the upper face of the stopper film 11. Therefore, the terminal point can be precisely defined, and the CMP process can be accurately stopped.

In FIG. 4D, the second film forming step is performed.

In FIG. 4E, the sputtered films 12, which are formed on the surface of the resist pattern 10 in the second film forming step, are removed by the CMP process. The terminal point of the CMP process can be exactly defined by the stopper film 11.

Further, in FIG. 4E, the stopper film 11 on the surface of the resist pattern 10 is removed. The stopper film 11 can be removed by, for example, a reactive ion etching (RIE) process.

In FIG. 4F, the resist pattern 10 is removed.

In FIG. 4G, a cross-section of the pole end part of the main magnetic pole 14, which is located in the vicinity of the air bearing surface, is formed into an inverted trapezoidal shape by an ion milling process. The stopper film 11 is left under the main magnetic pole 14, but the stopper film 11 does not influence characteristics of the main magnetic pole 14.

Note that, the cross-section of the pole end part of the main magnetic pole 14 need not be formed into the inverted trapezoidal shape. In case that the cross-sectional shape of the main magnetic pole 14 is defined by the configuration of the concave section 10a of the resist pattern 10, the ion milling process may be omitted.

In case of forming the main magnetic pole having the multilayer structure, thicknesses of the laminated films must be precisely controlled. Especially, the upmost film of the main magnetic pole highly contributes to writing data, so precisely controlling the thickness of the upmost film is important to restrain dispersion of characteristics of vertical magnetic heads. Thus, by precisely controlling the terminal point of the CMP process with the stopper film 11, the thickness of the upmost film of the main magnetic pole can be exactly controlled.

In case that the thickness of the resist pattern is thicker than that of the main magnetic pole, by forming the stopper film 11 on the resist pattern 10, over-polishing the resist pattern 10 can be prevented, so that polishing the laminated films of the main magnetic pole can be prevented.

In the production method of the present invention, the laminated films constituting the main magnetic pole can be flatly and orderly formed, and the magnetic head having the prescribed write characteristic can be produced. Especially, the sputtering process (the film forming process) is performed a plurality of times, and the films are laminated in the concave section of the resist pattern under the suitable conditions for flatly forming the films. Therefore, even if the main magnetic pole is micronized, the multilayer structure of the main magnetic pole can be securely formed.

The laminated films are formed, by the resist pattern, on the basis of the planar shape of the main magnetic pole to be formed, and then the pole end part of the main magnetic pole is ion-trimmed so as to shape the pole end part. In comparison with the conventional method in which the multilayer structure is merely formed on the substrate and the multilayer structure is ion-trimmed to form the main magnetic pole(s), the method of the present invention is capable of highly precisely form the main magnetic pole.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of manufacturing a vertical magnetic head,
comprising the steps of:
forming a resist pattern including a concave section, whose planar shape corresponds to that of a main magnetic pole to be formed, on a wafer substrate;
laminating a plurality of films in the concave section until forming a prescribed multilayer structure of the main magnetic pole; and
removing the resist pattern after laminating the films,
wherein inner faces of the concave section are perpendicular to a surface of the wafer substrate in said forming step,
said laminating step includes the sub-steps of:
(a) performing a sputtering process, in which particles are perpendicularly sputtered with respect to the surface of the wafer substrate, a prescribed number of times so as to flatly laminate the sputtered films in the concave section; and
(b) removing the sputtered films, which have been stuck on a surface of the resist pattern in the sub-step (a), from the surface of the resist pattern by an abrasive process, and
the sub-steps (a) and (b) are repeated, in said laminating step, until the prescribed multilayer structure is formed.

2. The method according to claim 1,
wherein a cross-section of a pole end part of the main magnetic pole is formed into an inverted trapezoidal shape, by an ion trimming process, after said removing step.

3. The method according to claim 1,
wherein the sub-step (a) is performed by a point-cusp magnetic field sputtering apparatus.

4. The method according to claim 2,
wherein the sub-step (a) is performed by a point-cusp magnetic field sputtering apparatus.

5. The method according to claim 1,
wherein a position of exposing the surface of the resist pattern is detected as a terminal point of the abrasive process of the sub-step (b).

6. The method according to claim 2,
wherein a position of exposing the surface of the resist pattern is detected as a terminal point of the abrasive process of the sub-step (b).

7. The method according to claim 3,
wherein a position of exposing the surface of the resist pattern is detected as a terminal point of the abrasive process of the sub-step (b).

8. The method according to claim 4,
wherein a position of exposing the surface of the resist pattern is detected as a terminal point of the abrasive process of the sub-step (b).

9. The method according to claim 1,
wherein a stopper film is formed on the surface of the resist pattern after said forming step, and
the stopper film is used as a stopper of the abrasive process of the sub-step (b).

10. The method according to claim 2,
wherein a stopper film is formed on the surface of the resist pattern after said forming step, and
the stopper film is used as a stopper of the abrasive process of the sub-step (b).

11. The method according to claim 3
wherein a stopper film is formed on the surface of the resist pattern after said forming step, and
the stopper film is used as a stopper of the abrasive process of the sub-step (b).

12. The method according to claim 4,
wherein a stopper film is formed on the surface of the resist pattern after said forming step, and
the stopper film is used as a stopper of the abrasive process of the sub-step (b).
